(19) United States
(12) Patent Application Publication
(10) Pub. No.: US 2006/0193125 A1
(43) Pub. Date: Aug. 31, 2006

(54) Lamp

(75) Inventor: Holger Fluss, Remscheid (DE)

Correspondence Address: THE FIRM OF KARL F ROSS, 5676 RIVERDALE AVENUE, PO BOX 900, RIVERDALE (BRONX), NY, 10471-0900, US

(73) Assignee: ERCO Leuchten GmbH

(21) Appl. No.: 11/091,356

(22) Filed: Mar. 23, 2005

(30) Foreign Application Priority Data
Feb. 25, 2005 (DE) 102005009228.4

(51) Int. Cl. F21S 8/00; F21V 9/00

(52) U.S. Cl. 362/145; 362/231

(57) ABSTRACT

Shown and described is among other things a lamp or luminaire (10, 10a, 28, 29) for illuminating building surfaces, parts of building surfaces, or exteriors (12).

The special features comprise among others that the lamps have a memory (25, 26, 27, 31, 32, 33, T, 25a, 26a, 27a, 25b, 26b, 27b) in which a singular factory applied code (light ID) is registered and serves to identify the lamp and is electronically readable.

The invention relates, at the first instance, to a lamp for illuminating buildings, building parts or exterior areas according to the preamble of claim 1.

Such lamps are known and widely used. Typically each lamp has a respective lamp housing for accommodating at least one light source. It can also be provided that in or on the lamp but in any event fixed relative to the lamp, that a plurality of light sources are arranged.

The invention relates to internal and external lamps, whereby when reference is made to parts of a building, it is thereby intended to refer to the surfaces of an illuminated object, for example a painting or a sculpture. As lamps for illuminating a building surface, orientable lamps are frequently indicated which can be fixed in or on a building or arranged on a building surface and which at a first level serve to cast its illumination, for example through a glass window of the lamp at a particular orientation point in the structure. Such an orientatable lamp is for example known from DE 19 956 799 A1 of the present applicant.

From DE 19 817 073 A1 of the Applicant, it is already known to connect a plurality of lamps in a system for controlling a multiplicity of lamps, that is in a network. The individual lamps are individually addressable by a control unit and can be operated by control commands which are supplied for example over a separate signal transmission line, for example a two wire system but also through the current supply lines of the lamps. The lamps can respond to one or more control units and can for example be turned on or off or dimmed or provided with color changes, or blinked or flashed or with like functions.

The invention is directed especially to a lamp which can be connectable in a system for controlling a multiplicity of lamps and is thus connectable with other lamps and with one or more control units for the multiplicity of lamps.

The invention is thus directed especially, but not exclusively to a lamp for use in a network of lamps which operate in accordance with the DALI protocol. The DALI (Digital Addressable Lighting Interface) protocol is a protocol for signal connection to lighting systems which has been developed by the collaborators of the DALI association at the Central Association for the Electrotechnical and Electronics industry eV (ZVEI).

From the published handbook of DALI AG “Dali, Eine Aktivitat des Betriebsausschusses im ZVEI,” Richard Pflaum, publisher, Munich, there is described a system for controlling a multiplicity of lamps in which for each lamp in the DALI network a respective DALI switching device is provided and which includes a memory into which can be written the address data, light scene information and like data from a control unit. The lamps connected into a DALI network are interconnected through a signal transmission line and, as is self understood, operate in accordance with the DALI protocol. The control units produce, when the system is first set in operation when interconnected before being located on site or upon site mounting, first an initialization process to recognize the individual participants and provide them with corresponding brief addresses (DALI addresses). For this purpose it is known to have the control unit transmit a command to all lamps which serves to have each DALI switching unit generate a random number. Then as a result of communication between the control unit and the different DALI switching devices the individual lamps can have their respective switching devices supply the respective different random addresses.

The individual switching devices are then identifiable in the network by the brief addresses and later, after the initialization, these addresses are used in operation of the lamps for their control. In operation, it is customary for service personnel to identify the location of the mounted lamps which have been recognized by the control unit by manually blinking the individual lamps or the individual sources of the lamps to indicate where those lamps or the corresponding light sources are disposed and which of the switching devices recognized by the control unit belong to which lamps. Especially with lamps with differently colored light sources it is possible that one lamp can have a plurality of switching devices which in the course of the initialization phase, that is after mounting of the lamp with the switching device in place, the user of the control device must determine which switching device is associated with which lamp.

The object of the invention is to improve the known lamps or luminaires so that a more convenient use of the lamps or luminaires in a network of lamps or luminaires is possible.

The invention satisfies this object with the features of claim 1 and especially with its characterizing part and is thus characterized in that the lamp or luminaire has a memory in which an electronically readable identification-enabling signature or code is provided which is singularly associated with the lamp and is established at manufacture thereof.

The principle of the invention is basically to provide the lamp or luminaire on manufacture, that is during or after their assembly, with a characterizing or unambiguous, that is singular, individual and exclusive signature or code, used only for that lamp, and applied to the lamp. For the case in which the lamp is to have one or more switching devices, the signature or coding is preferably entered into a memory which is provided for the switching device or the plurality of switching devices. Each lamp is, with and as a consequence of its manufacture provided, with a serial number comparable with the individual vehicle identification number of an automobile that is used only on a one time basis and will identify that lamp over its entire life.

The singular signature or identification code is part of an ordered system or derived by an algorithm which allows each signature or lamp code to be distinguished from another signature or lamp code of another lamp. For example, it is possible for the signature or lamp codes to be stepped with numbers 1, 2, 3 . . . etc.

The ordered system or ordering algorithm thus ensures that double numbering will not occur. The signature or lamp code can be formed from a date and day data input which gives the point in time at which the lamp is provided with the signature or lamp code. All that is necessary in that case is a device which can provide the lamp with the signature or lamp code and a memory in the lamp for the signature or lamp code into which that signature or lamp code can be written and the device can always provide each lamp with the appropriate signature or lamp code so that the date and time data inputs of the inscription of the signature or lamp code in the lamp will form an appropriate ordering system or follow an appropriate algorithm to ensure the singularity of the signature or lamp code. If there are a number of devices which can provide the lamps with the signatures and the lamp codes, the different devices can contain different device numbers which are applied together with the date and time data elements. As a result, an order system is obtained which can ensure the singularity of each individual signature or lamp code.

For the signature or lamp code, a test sum or test digit can be provided such that from the signature or lamp code or optionally from other data, the information registered in the memory of the lamp can be calculated or reviewed as a verification of the signature or lamp code on readout and to ensure that a proper signature or lamp code is obtained from each lamp. The application of the singular signature or lamp code to each lamp enables the later conversion of the signature or lamp code to data information as to the lamp of concern. Simultaneously it is also possible to convert only a part of the signature or lamp code to the data and information referred to the lamp, for example when the signature or lamp code is comprised of a kind of series number and additionally, for example, to an article number for the lamp and the data with respect to the article number can serve to allow the lamp to be identified by reference to this piece of number. The data or information can be supplied for example to a data bank of the control unit which may be central to the network of lamps. The control unit can be connectable with the lamps and electronically read out the signature or lamp code.

In this connection it is to be noted that a computer or calculator is connectable with the control unit or can be provided as a component of the control unit. The data bank in this case can also be provided in the unit and the control unit can be then configured as a relatively simple controller, which after reading out the data bank from the computer contains only rudimentary control information so that the computer can be detached from the control unit after transferring the control information thereto.

As need arises it is also possible for the control unit or a computer associated with or associatable with the control unit to contain the ordering system or the algorithm or a list of previously applied signatures or lamp codes and based on a comparison of the signatures or lamp codes in a data bank or data base or a part of the signature, with the result of an electronic read out of the signature or lamp code contained in a memory of the lamp, to recognize a special lamp of this order.

The reference to the application of the identification, code to the lamp or luminaire on manufacture also includes the application of the code first at the use location of the lamp, but in any case before it is brought into operation for the first time. For this purpose it is required that the application of the code or indicia to the lamp be part of a part of a systemic arrangement or a systemizing algorithm which can then ensure that the indicia or coding for each lamp is of a singular nature, i.e. applied to only one lamp of the system.

The placing of the lamp, which is provided with one or more of the indicia or codes applied at the manufacturing location, in operation in a network of such lamps is thereby significantly simplified. A control unit which is connected with the lamp can read out the identification or code, automatically or in a largely automatic manner. The placing of the lamps in their operating locations in a network can then be simplified especially when a lamp is associated with a plurality of devices in series therewith. Since the coding is preferably written into a memory of the device associated with the lamp and the several switching devices which may be associated with a single lamp can be provided with identical codes, the control unit can immediately recognize which devices are in series with the lamp. A manual determination, for example by blinking the lamps as has been the case in state of the art techniques can, thereby, be eliminated.

A start up of the lamp in the network of lamps can also be simplified in that the control unit can be provided with the code or a part of the code in the form of data or information as to the lamp and can also serve to recognize the lamp by its article number as part of the code from a database which can include information as to the lamp type, thereby enabling the lamp itself to be visualized for example on a monitor. The user, upon start up of the lamp, especially where different lamp types are provided, can simply recognize precisely the type of lamp or whether the lamp used at a particular location is of the correct type.

The invention is especially advantageous, particularly upon the removal of a previously installed lamp from an existing network and its incorporation in another network to utilize the invention. This situation arises, commonly in a museum in which, upon a changeover of a display and the creation of a new lighting situation, many lamps may have to be removed from one room and placed in another room. The lamps or luminaires according to the invention because of their singular coding which remains permanently with the lamp, can again be identified after a changeover from one room to another after they have been incorporated in a new network. An integration of new lamps in an existing network and a monitoring of the lamps or properties of a lamp over the life thereof is possible without difficulty since each code is different. While the lamp in a new network can be provided with a new brief address which is appropriate only for the new network, the lamp itself remains identifiable and, for example, can be monitored by a museum central which is capable of monitoring a multiplicity of different networks. Should need arise the museum central can immediately find specific lamps or certain types of lamps wherever they may be located.

It is especially advantageous that the lamps, based upon their individuality, can be provided with a luminaire-related coding before their first start up, that is the lamp already will have a coding which is independent of the control unit or of the network into which that lamp is inserted and in which in the state of the art may have established an initial address of the lamp. In this manner it is possible to record in the control unit, for example in the form of a database, information as to these lamps and which, because of the singular characterization or coding of these lamps, allow them to be accessed individually. Thus the control unit after the initialization of the lamps according to the invention in a network will already know that a certain lamp has a certain light source or needs a certain light source or that the light source has a certain light color or that a lamp of a certain type is available. The control unit or a computer assigned to the control unit can be provided for example with software for the selection of such information.

The formulation to the effect that the memory or storage in which the singular lamp code has been inscribed or registered is electrically readable, encompasses typically such memories or storage which can be directly electronically readable, for example EE-PROM memories, which can also be overwritten, but however in any case can be directly read by the control unit. The formulation as to electronic readability however also should encompass such memories which for example are configured as magneto-optical storage and in which the characteristic reading process is effected optically or electromagnetically or the like. The type of reading process is not significant. What is important is that the control unit be able to ascertain the coding via a signal transmission line in an electronic or electrical manner.

It should be noted in this connection that the signaler coding which is written into memory in principle can be permanently stored therein and to that extent will enable identification of the lamp over its entire life. In the case of use of the DALI switching units, the use of light scene memories is recommended as the code storage, particularly an EE-PROM memory, which can be overwritten. The invention enables the use of methodical connections between the control unit and the DALI switching devices which are not employed for light scenes during operation of the network or which only use part of the light scene memory of the DALI switching unit for light scene information in operation of the lamps but are otherwise available for storage of the lamp codes. In this case, the coding can be stored permanently for identifying the lamps.

Apart from the aforementioned advantages in the case in which there is to be a change in the placement of the lamps and connection of the lamps into new lamp networks, the lamps of the invention can also especially be simply located. The location of a lamp for example in a museum which may have thousands of lamps can be done in an especially simple manner since each lamp has a singular characterizing code. Should for example it be important to know when a certain lamp has been last cleaned or when a certain lamp has had its light source last replaced, this information is readily ascertainable electrically using software which can access a database in which the lamp code and this information has been stored to recover this information directly.

For the sake of completion it can be noted that memories have been described for DALI switching devices already known in the art which can be provided on fabrication with 24-bit addresses and in which upon manufacture of the switching device bit sequences can be registered in the memory which, while not providing a singular code for the device since coding can be altered many times and since there is no ordering system which can ensure that any coding will be singular to the device, does permit code storage. Especially with this state of the art, lamps can be installed in a network only in a laborious manner when a lamp must have a plurality of switching devices. In this state of the art the lamps are not associated with singular codes but rather the switching devices are inscribed with random bit sequences.

According to a refinement of the invention the lamps or luminaires each have a housing for at least one light source. The housing enables the lamp to hold the light source or a number of light sources or to have the light source or sources fastened thereto, as well as the possibility of providing the memory or storage in the housing. Alternatively the memory can be applied outside the housing, however, fixed in a spatial relationship to the housing.

According to a further advantageous refinement of the invention, the memory is fixed relative to the housing and, especially, is arranged within the housing. In this fashion a clear spatial relationship is provided between the memory and the individual light sources based upon the coding of the individual light source.

According to a further advantageous feature of the invention, the lamps have at least one switching device connectable with a control unit and responsive thereto, for controlling at least one light source. The control units can be connected with the switching device over a bus system and, for example over a bus system operating in accordance with the DALI protocol. The bus system can be, for example, a two branch signal transmission line. The electronic switching device also connects the light source with a voltage supply source. Depending upon the signals which are received from the switching device from the control unit over the signal transmission line, the voltage supply lines can be directly connected to the light source, can be interrupted or optionally dimmed, can supply the voltage in a cyclical or periodic manner or the like. The switching device is arranged within the housing or in the direct vicinity of the housing.

The switching device can be a conventional DALI (Digital Addressable Light Interface) electronic control gear (ECG) as can be obtained commercially, for example, from the Phillips, Tridonic or Osram firms commercially. Advantageously, the switching device or electronic control gear is fixed to the lamp. The fixed connection of the switching device or electronic control gear with the lamp can also be flexible and for example fabricated as a segment of the voltage supply line between the light source and the switching device. When a switching device or electronic control gear of this type is provided, the memory or storage can be provided in or on the switching device or electronic control gear.

When a DALI electronic control gear is used, the memory generally provided in the DALI electronic control gear, that is the known memory, can be used to receive the individualized code for the particular lamp.

The term “switching device” as used in the present patent application thus includes a switching device in series with the lamp between the light source and the voltage supply source, an electronic control gear in the DALI sense (electronic control gear), a series switch or a superimposed switch, that is a switch to which the light source will respond or a lamp switcher, that is any possible operating device for any possible type of light source which is used. For example, under the term “switching device” an electronic control unit for fluorescent lamps may be understood, or equally a control unit for LEDs, for example, for a group of red, a group of green and a group of blue LEDs. The term “switching device” also is intended to include transformers or units configured to operate as high voltage dimmers for light sources used to operate lamps and which respond to a control unit, for example a DALI controller, in a network.

According to a further advantageous feature of the invention, the memory is readable by the control unit. This enables the incorporation of the responsive lamp in network of lamps in an especially simple manner.

According to a further feature of the invention, the control device is an electronic control gear or DALI electronic control gear. This enables the use of commercially available components and modules.

According to a further feature of the invention, the code is registered in a light scene memory of the DALI electronic control gear. This enables on fabrication the application of an individual code to the lamp and a use of the latter directly from the memory of the DALI electronic control gear. The need for a separate memory is therefore eliminated.

According to a further advantageous refinement of the invention the code for the individual lamp occupies places 7 to 16 in the light scene memory or store. A DALI electronic control gear contains by definition, as can be seen for example from the previously cited DALI Handbook, sixteen light scene storage places. The configuration of the invention enables the use of several light scene storage places for generating the light scene, since for the storage of the singular code, only light scene storage places 7 through 16 will be occupied. The light scene storage places 1 to 6 remain available therefore for storing the light scene itself.

To be noted is that by the use of intelligent control of the DALI control device through the control unit there is no need to revert to the light scene storage places. By the incorporation of the code in a memory provided in the DALI electronic control gear for the light scene storage places, the functionality or the functional range of the switching device is in principle also not limited.

According to a further feature of the invention, by means of the coding the switching device is identifiable singularly itself or is singularly identifiable as associated with the lamp. For the case in which the lamp has only one switching device or electric control gear in circuit therewith, the coding not only singularly identifies the lamp but also the single switch device assigned to that lamp.

For the case in which the lamp may have a plurality of switching devices the switching devices will be provided with the same code so that for the control unit it will be clear that these switching devices belong to the same lamp. The switching devices are identifiable as belonging to the same lamp. This enables the initialization of a lamp and the incorporation of lamps into a network where lamps are to be provided which have a plurality of switching devices each.

According to a further feature of the invention the memory is assigned to the switching device or electronic control unit and especially is arranged in the switching device or electronic control unit. Even in the case in which a switching device other than a DALI electronic control gear is used it has been found to be advantageous to provide the memory so that it is directly associated with or built into this switching device or electronic control unit. This simplifies the incorporation of the lamp in a network of lamps to the extent that the control unit is the electronic control gear itself and contains the address within the network and is the means by which the lamp when arranged in the network is addressed. By a direct addressing of the switching device or electronic control unit, it is possible to read out directly from the memory the code of the control unit. The assignment of the memory to the switching device or electronic control unit can be accomplished by electronic or electronically connecting the memory with the electronic control unit or switching device. It can also be accomplished by mechanically connecting the memory with the switching device.

According to a further refinement of the invention, the lamp or luminaire has a plurality of light sources and a plurality of switching devices and electronic control units. Nevertheless the lamp can be provided with only a single coding which characterizes the lamp individually, so that in this case, a plurality of switching devices or electronic control units of the single lamp will have the same code.

According to a further feature of the invention, a plurality of switching devices of a single lamp will each have a respective memory assigned thereto and all will have the same code. In that manner, different switching devices of the control unit, upon reading of the code from the respective memory, can be recognized as belonging to the same lamp.

According to a further feature of the invention, a plurality of switching devices or electronic control units of a lamp are each provided with a different subcode at the time of manufacture which is electrically readable and serves to identify the individual switching device or electronic control unit. For the case that a single lamp has a plurality of switching devices or electric control units, for example a respective switching device for each of the three different colors of light sources of the colors red, green and blue, the subcode enables the particular switching device to be accessed for a particular lamp upon placing the lamp in operation. The subcode for the respective switching device can be in addition to the code applied to the lamp so that upon incorporation of the lamp in a network the identification of the lamp as well as an ability to distinguish the three switching devices thereof can be recognized.

By contrast with the singular code, which is like a serial number and which is applied once, the subcoding, depending upon the different lamps which may be used, can be applied a number of times. It is only important that for each switching device of a lamp, a singular subcoding is provided, for example in the case of the application of three switching devices to a single lamp, these can be provided with subcodes a, b, c or 1, 2, 3 or the like. Since all three switching devices apart from the different subcodes will have the identical coding for the lamp in each of them, the control units can be simply, rapidly and reliably recognized upon initial operating system initialization or the incorporation of a lamp in a network.

According to a further refinement of the invention, each light source is associated with a switching device or electronic control unit. This enables a separate addressing for each individual light source via the switching device.

Alternatively, it is possible to provide two or more light sources in a lamp, so arranged that they are addressable through a common switching device at electronic control unit. This may be possible however only under certain circumstances, namely when not every light source is intended to be individually addressed. A group of light sources can especially be addressable from a common switching device when the light source are formed by LEDs. In one lamp, a plurality of switching devices or electronic control units can be provided which respectively each address a group of light sources.

According to a further feature of the invention, the code includes a check sum. For example the code can be comprised of seven bytes and a check sum formed by an eighth byte. From it a conclusion can be drawn, as to whether the data inscribed in a light scene memory of a lamp by the control unit as the code is inadvertently or erroneously in error and thereby capable of misunderstanding.

It can be noted that especially in the use of a DALI electronic control gear or switching device with a light scene memory for the code, the code can be inscribed erroneously. This situation can for example arise when in an unauthorized manner in the light scene memory positions 7 through 16, which contain the coding, a light scene is written as information. Such a data change in the memory has, however the consequence that it will also change the test sum which would ordinarily apply so that the control unit during an interrogation or read out of the codes and the test sums can determine that the altered light scene memory does not have a proper code.

In the same manner, the control unit can establish also when lamps are connected in a network but do not have a proper code, for example because they may derive from another manufacturer who does not apply a code.

In both of the last mentioned cases in which a lamp may be found in the network or is provided with a connection to the network and nevertheless does not have any code or has a code which cannot be determined, the invention provides that by means of a portable computer the lamp can, at the point of its installation or location, be provided with a singular code. To ensure that this computer will be able to generate the new code for the lamp in the original code or system or with the original code or algorithm, the computer must be so connected or programmed that it can produce such single use one time singular codes. The issuance of the code by the computer which can be equivalent to the application of the code on manufacture is facilitated if the computer is associated with the manufacture.

According to a further feature of the invention the check sum can be tested by the control unit. This enables distinction between an original, that is factory applied code, and light scene memory information which might be inscribed in memory at a later date and which has no lamp-singular code.

The invention also relates to a lamp according to the preamble of claim 17.

The invention has as an object to so improve a known lamp of this type that it can be conveniently installed in a lamp network and can be conventionally operated in such a lamp network. The invention achieves this object by the features of claim 17, especially those of the characterizing clause and itself is characterized in that the lamp has a memory in which an information data set can be described at the factory and which contains lamp-type specific data like the article number of the lamp and/or the number of the switching device or electric control gear or unit assigned to the lamp and/or the number of the light source, and/or the color (color code) of the light source, or the like.

The information data set inscribed in the memory at the factory can be an addition to the code in the memory. The information data set can also be components of the code. It can however be inscribed also independently of the code so that the lamp according to the invention need not compulsorily have a singular code.

As lamp-type-specific data, for example, the article number of the lamp, the number of switching devices or electronic control units assigned to the lamp, the number of light sources, the types of light sources of the lamp or the colors of the light sources are intended. Depending upon conditions, information can also be included as to components of the lamp, for example, for repair purposes, as parts of the information data set. The control unit can read out the informaiton data set and use it. Especially the light type specific data can be further processed by the control unit. For example, it is possible to carry out a signal processing or data processing that considers the lamp types represented by the article numbers and can distinguish the technological functions of the different lamps or determine whether or not the intended functions can be fulfilled by the lamps. The control unit can for example also draw upon the information as to the number of light sources or the types or colors of the light sources and allow the operation of the network to rely upon such data for the lamps. The entire information data set which is applied at the factory and like the lamp-individualized code is applied prior to the first installation of a lamp or luminaire at the place of use, is thus already present in the lamp at the time it is to be installed and can be detected by the control unit, thereby simplifying initial installation and making the latter operation fo the lamp more convenient.

A typical example of use of the data contained in the information data set, where the information data set includes the to a data base, is to permit the control unit to draw upon the information contained in that data base for the different article numbers.

For example the control unit when it has read out the electronic memory can refer to the data base for the particular lamp with the particular article number, and pull up a photograph or image of the article and display it. The control unit can thus allow the user, should he so desire, to be able to view the lamp. This simplifies for example the finding of the lamp at its site since the user can then recognize the basic shape of the lamp.

The invention relates moreover to a lamp according to the preamble of claim 18.

The invention is an improvement over a lamp in accordance with this state of the art in which a plurality of switching devices or electronic control units are provided with which different light sources of the lamp can be controlled.

The invention has as its object to so improve the known lamp of this type that it can be connected in a simple manner in a network with a plurality of lamps and that in this network it can be operated in a convenient manner.

The invention attains this object with the features of claim 18, especially those of the characterizing clause and is characterized in that the lamps have a plurality of switching devices or electronic control units each and in that each switching device or electronic control unit has a memory into which at fabrication, a data set is registered which contains lamp-type specific data and/or switching device data like the article number of the lamp, the color of the light source to which the switching device is connected, the type of light source connected with the switching device or the like.

The data set can be written into the memory in addition to the code. With this aspect of the invention however it is not imperative that the lamp or luminaire also have a code.

The lamp or luminaire has a plurality of switching devices or electronic control units in which each switching device or electronic control unit is provided with a data set at the factory and which advantageously in addition to the code contains lamp type specific data associated with the switching device or electronic control unit, like for example the article number of the lamp, the color of the light source connected with the switching device or electronic control unit, the type of the light source connected with the switching device or electronic control unit or the like. The data set can differ from the aforedescribed information data set although it is not essential that it be different, can be provided in the switching device or electronic control unit and for example in the case of a DALI switching device or electronic control gear, can be arranged directly in a light scene memory of the switching device or electric control gear. In this connection it can be noted that the previously mentioned information data set can also be understood to be contained in a light scene center of the DALI switching device. In addition, the data set can be directly assimilated by the control unit and especially stored there or used by it. It is available after an initialization of the lamp for later control of the switching devices or the associated lamps. This facilitates the operation of a number of lamps in the network.

The control unit with which the lamps are connnectable can evaluate the data information contained in the data set or receive this data information and use it by referring back to the information on operation of the lamp network. This also applies to the [lamp or unit identifying] data set or the information data set mentioned above.

According to a further advantageous feature of the invention, the control unit by means of the code or by means of the information data set or by means of the data set of the lamp or of the switching device can be set up. The set up means that the control unit can access the lamps installed at their various locations and which at the factory have been supplied with certain information which is stored in a data base which can be accessed by the control unit. The information supplied at the level of the lamp can include for example the code or a part of the code and/or the information data set and/or the data set. The control unit can store this information and/or use it later. The data can be used when the lamps are controlled. It can also be addressed by computers and/or other control units which can be connected with the particular control unit.

For example, a control apparatus or central controller of a museum having a multiplicity of control units which are connected with the central controller, can be addressed or interrogated to establish which lamps of a certain type are connected with the individual or respective control units and where they are located. The control units can transmit this information directly to the central controller. This advantageously provides a possibility of immediately establishing the respective locations of particular lamps. Alternatively, optional data associated with particular lamps can be simply and conveniently accessed, called up or interrogated.

In addition, the invention relates to a method of making lamps according to the preamble of claim 20. Such a method of making lamps is known and has been practiced by the assignee for decades. Especially it has been customary in the fabrication of lamps to produce individual parts like reflector elements, holders for light sources, switching devices or electronic control units initially separately or to purchase them and to assemble the lamps thereafter in a final production step to a unit.

Starting from this known fabrication method, the invention has as its object to develop the method still further so that the fabricated lamps can be conveniently incorporated in a network without causing additional expense in the fabrication process. The invention achieves this object with the features of claim 20 especially the characterizing clause thereof and is thus characterized by a method step provided in which each lamp is provided with a singular code.

The principle of the invention thus resides in the provision, as an additional process step in the known method of producing lamps to impart to the lamp a singular code, that is a code which is used only once and is applied like kind of a serial number. While lamps of like type for example can have identical article numbers, based upon the singular code according to the invention each lamp can be distinguished from all other lamps. The code can especially advantageously be registered in a memory or storage, especially in an electronically readable memory or storage. Furthermore, it is advantageous to provide the method step in which the code is registered in the memory as an electronic operation. For this purpose it is advantageous at the point in time at which the code is to be provided to apply the code after the unit has been assembled and is already in its final stages or to the lamp in a partially assembled state by a computer or calculator which can be connected thereto and in which the code, for example is stepped in accordance with an order algorithm or conforming to an order system which ensures the singularity of the code, outputs the code and registers or inscribes the code in the memory provided in the lamp.

In addition to the mentioned code, in the same method steps an information data set or data set be registered or inscribed in the memory which can indicate whether the lamp provided with the code has one or more light sources, the types of light sources provided and the colors of the light sources, as well as the number of switch devices or electronic control units provided, and for example information as to the light type.

According to a further advantageous mode, the method step is largely or completely automated in that for example by machines or automatic apparatus, optionally with the assistance of a service person, detection of the lamp processed can be made.

Advantageously with the same, subsequent or preceding method steps information data sets according to claim 17 and/or data sets according to claim 18 can be inscribed or registered in a memory of the lamp. This enables a time saving application of this information onto or in the lamp.

While the additional method step in the fabrication process of the lamp can be carried out in a time conserving manner, it enables upon later installation of the lamp in a lamp network, a rapid addressing of the lamps, practically over the entire life of the lamp so that misidentification is excluded and the identification of the lamp is reliable independently from wherever it is located and set up with specific data information which is associated with the particular lamp.

The fabrication method according to the invention is applicable especially to lamps of the type described with features in accordance with the invention. To avoid repetition, reference may be had to the aforedescribed features which derive from the use of the method steps of the invention in applying the coding in the method steps.

Finally the invention relates also to a device according to the preamble of claim 21 especially for use in a method of producing lamps according to claim 20.

Such a device is known. It can have for example an automatic test unit which, following assembly or preassembly of the lamp, can be used to monitor its functioning ability. The known device used as an automatic test machine has for example electronic or electrical connections or contacts which can be connected with the lamp. Preferably in an automated manner the known device can carry out a test of individual components installed in the lamp or optionally the entire lamp, especially with respect to the wiring of the electric conductors which are arranged in the lamp housing or with respect to the usual electrical devices installed thereon like plugs, voltage regulator or protective device or the like in an automated manner.

Starting from the known device, the present invention has as its object to so improve the known device that a lamp operated thereby or cooperating therewith can be more conveniently operated in a network setting.

The invention achieves this object by the characterizing part of claim 21 and is therefore characterized in that a device is provided whereby each lamp operated by the device is provided with a singular code.

Where the device has an automated test unit, advantageously the test unit can inscribe the code in the memory of the lamp, especially as kind of a serial number which is advanced from lamp to lamp or comparably to the vehicle identification numbers of a succession of automobiles and thus with a code which is individual to the lamp, is permanent, is independent from the later location of the lamp and independent of other lamps in the network and of any controller in that network.

For the case in which the testing automaton is directly available at manufacture of the lamp, it will apply the code to the lamp or in the lamp. As a result the application of the code to the lamp can be done in an especially simple manner. The device can also be separate from the testing automaton and can be connected therewith for coding the lamp before or after testing the lamp for its normal functions.

The invention relates further to an operating device according to the preamble of claim 22.

This aspect of the invention relates especially to an electronic switching unit or electronic control unit or some other device for controlling a luminaire or lamp or a light source, or to a controllable electrical or electronic device which is connected with the lamp or the light source. It especially can be a control device for LEDs and for example for red, green and blue groups of colored LEDs, or a high voltage dimmer, a transformer or a conventional controller. Especially although not necessarily exclusively it can be a DALI electronic control gear for electronic control units, that is an operating or switching device for a lamp operating in according with the DALI protocol.

Starting from the known state of the art for such an operating device, when a lamp of the type described at the outset is used, it is an object of the invention to provide the operating device for such a lamp so that it can be used in a network of lamps to provide greater convenience.

This object is achieved with the features of claim 22 and especially those of the characterizing clause, namely the operating device can be provided with a memory in which a singular factory determined code enabling an identification of the operating device can be stored and can be electronically readable therefrom as the lamp identification (lamp ID).

To avoid repetition, reference may be had to the aforedescribed advantages which have been explained in detail for applying a singular code to a lamp. To the extent that the application of a code to a lamp has been described, it applies equally for an operating device or control unit for such a lamp.

Finally the invention relates also to an operating device in accordance with the preamble of claim 23.

The invention is based upon the last described state of the art.

The object of this aspect of the invention is to provide an operating device or control or switching unit which can be used more conveniently in a network of lamp and whereby the operating or switching device will have a more convenient configuration. The invention achieves this object with the features of claim 23 and especially those of its characterizing part and is characterized in that the operating device has a memory in which a data set is recorded or inscribed on fabrication and which contains data specific to the operating device like for example an article number of the operating device, information as to the verification of the outputs of the operating device, that is for example the specific outputs to which particular light sources or light source types are to be connected or the like.

To avoid repetition reference is made to the aforedescribed advantages which relate to the arrangement of a data set or an information data set in a switching device of a lamp. These advantages apply equally to the use of operating devices for such lamps.

Further advantages of the invention are found in the dependent claims which have not been referred to or will be clear from the following description of embodiments of the invention shown in the Figures. These are:

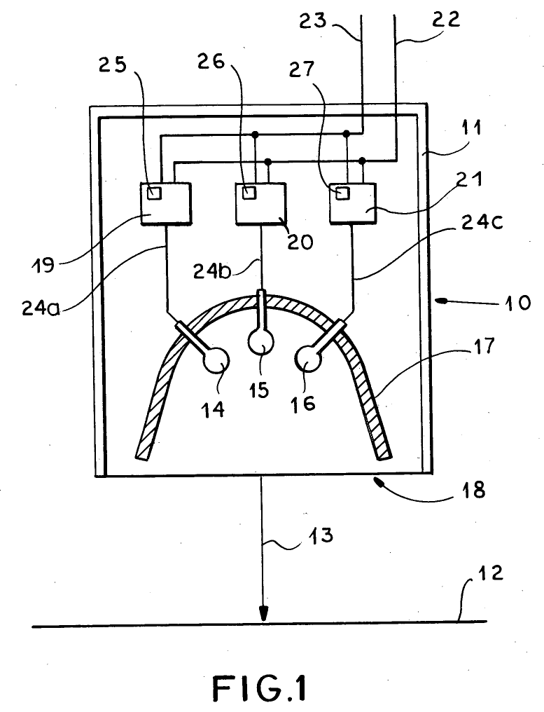

FIG. 1 a first embodiment in a schematic partially section elevational view of a lamp or luminaire according to the invention with the electrical pathways shown in a block diagram,

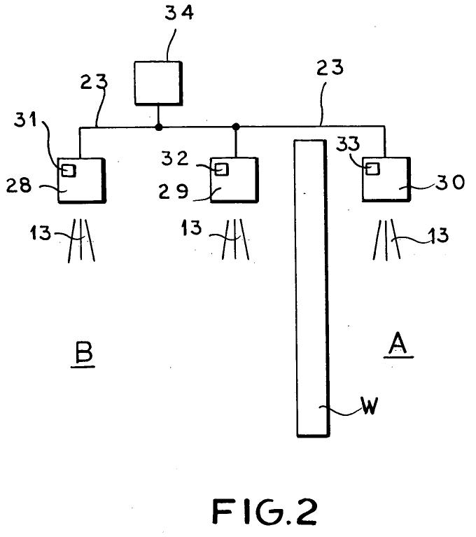

FIG. 2 a schematic block circuit diagram of an arrangement in which three different lamps or luminaires in two different rooms are shown and in which the three lamps are joined in a network with one control unit,

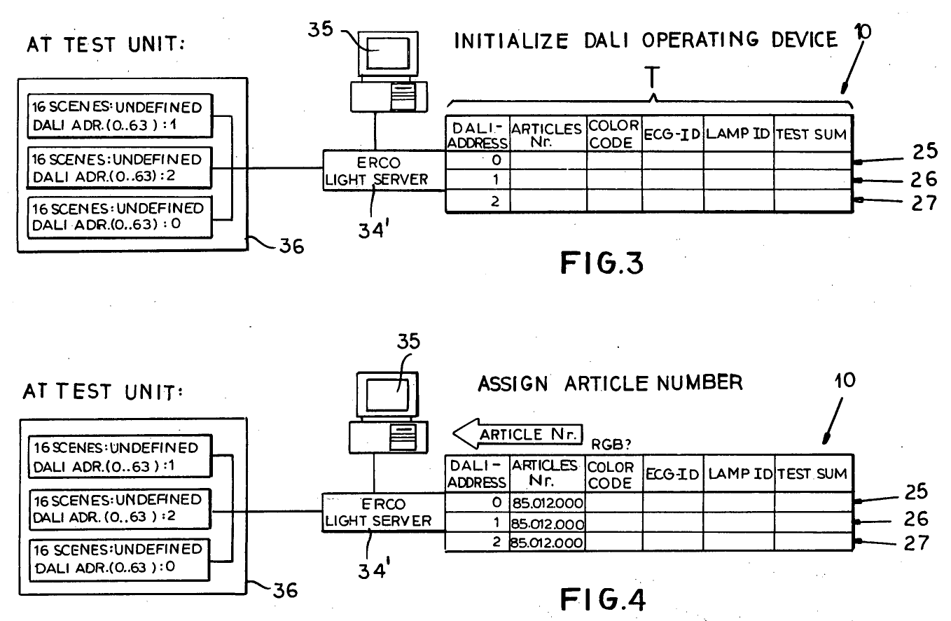

FIG. 3 a schematic block diagram-like illustration of a table field which reproduces the memory content of the three memories of the three lamp switching units according to FIG. 2 and indicating the DALI addresses assigned to the lamps at the three switching units and showing an automatic tester which has been symbolically represented and designated and is connected to a component referred to as a light server which simulates a control unit as well as an information field which can be read out and corresponds to the content of the memory,

FIG. 4 in an illustration according to that of FIG. 3 a table field which shows that meanwhile the article numbers of the lamp have been inscribed in the three memories of the three switching devices,

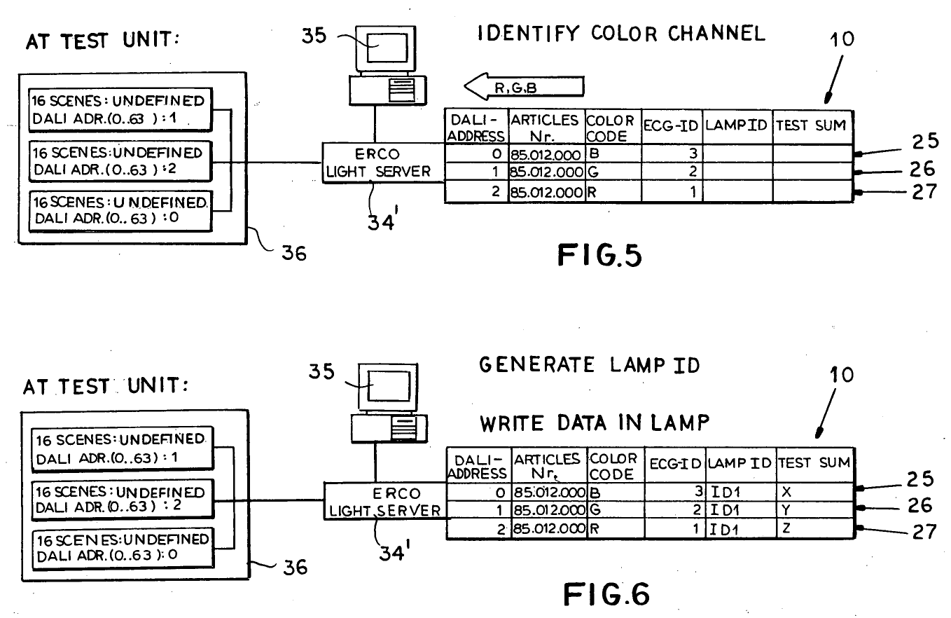

FIG. 5 shows the table field of FIG. 4 in which the subcode for the three switching devices and corresponding color codes for the light sources assigned to the individual switching devices have been registered in memory,

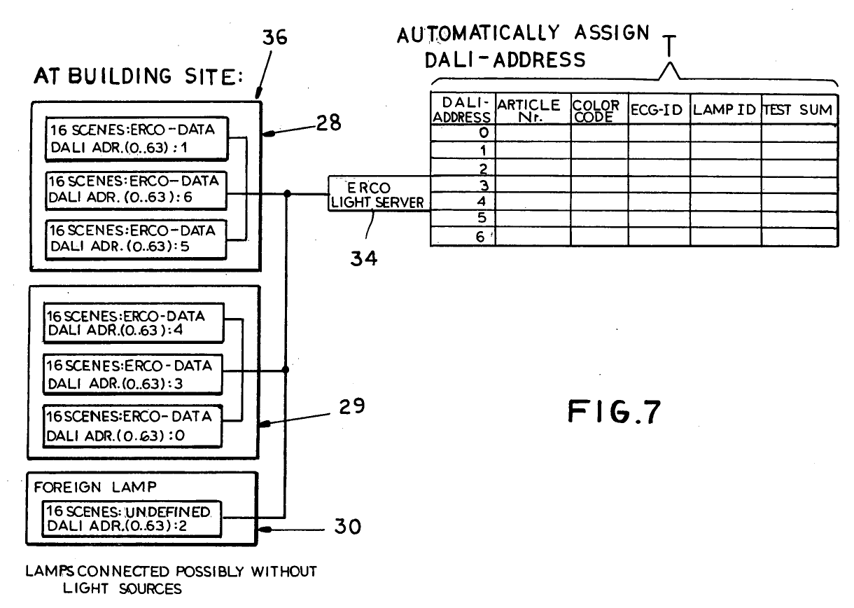

FIG. 6 shows the table field according to FIG. 5 in which in the memory for the three switching devices the same code for the lamp or luminaire has been recorded.

FIG. 7 in an illustration according to FIG. 6 the situation in which at the mounting site, that is at the location of installation of three lamps, in which the control unit has the DALI addresses which were randomly assigned,

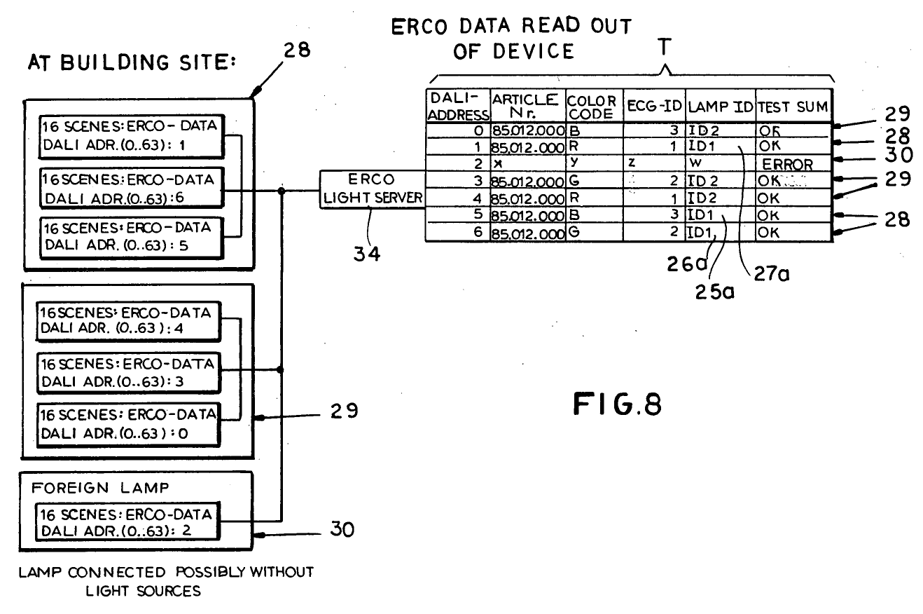

FIG. 8 an illustration according to FIG. 7 of the table field for the three different lamps or luminaires with altogether seven switching devices that shows that the memory contents of the memory of the seven switching devices in the control unit has not yet been sorted,

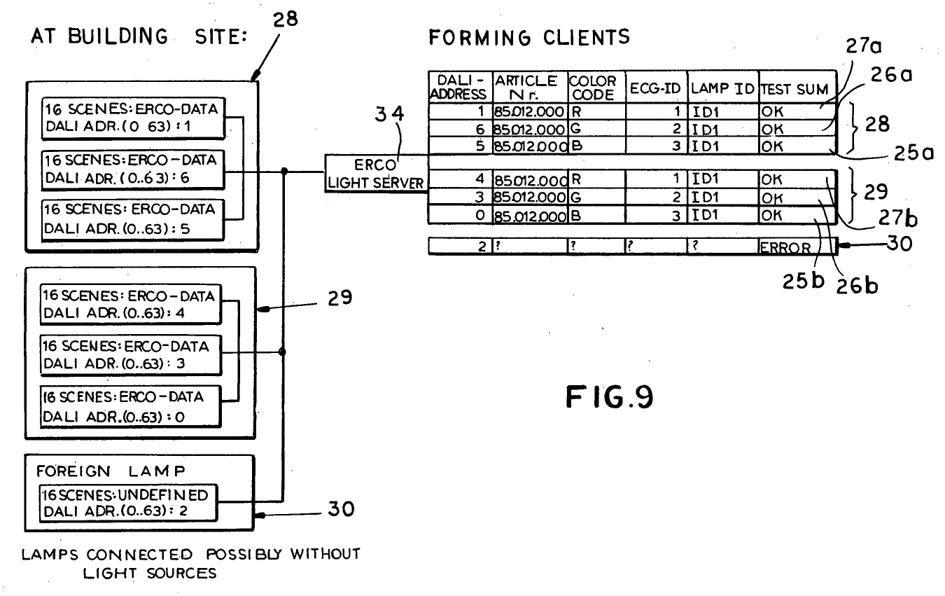

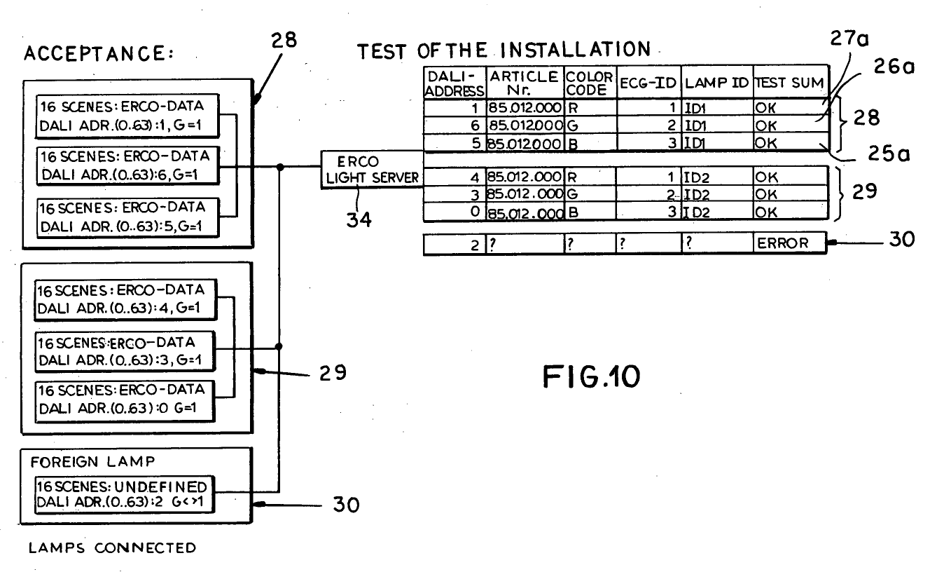

FIG. 9 an illustration as in FIG. 8 of the table field with the memory contents sorted and assigned to the individual lamps or luminaires,

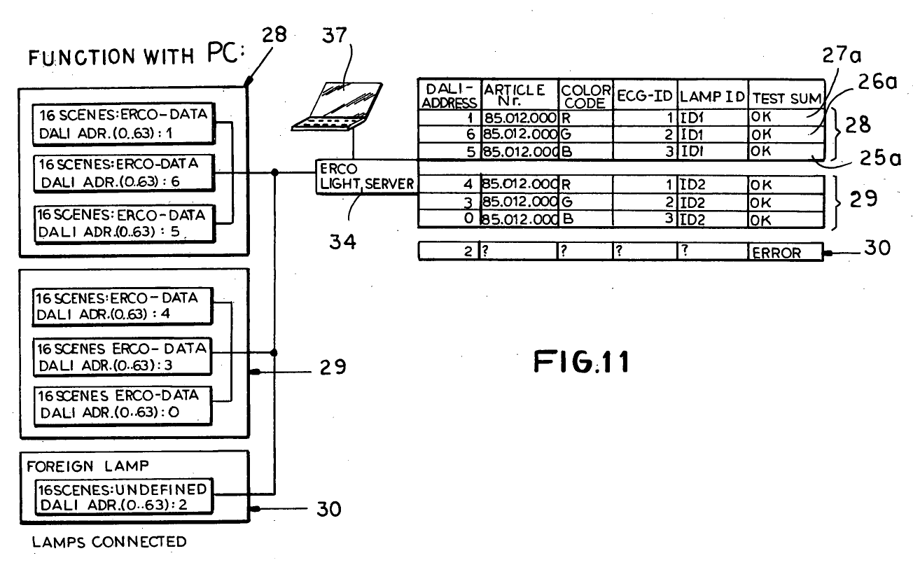

FIG. 10 an illustration as in FIG. 9 illustrating a mode of operation in a test state for the installed lamps,

FIG. 11 an illustration as in FIG. 10 with a schematically shown circuit for ascertaining a subsequent attribution from a code of another lamp or luminaire or at a luminaire with overwritten light scene memory, and

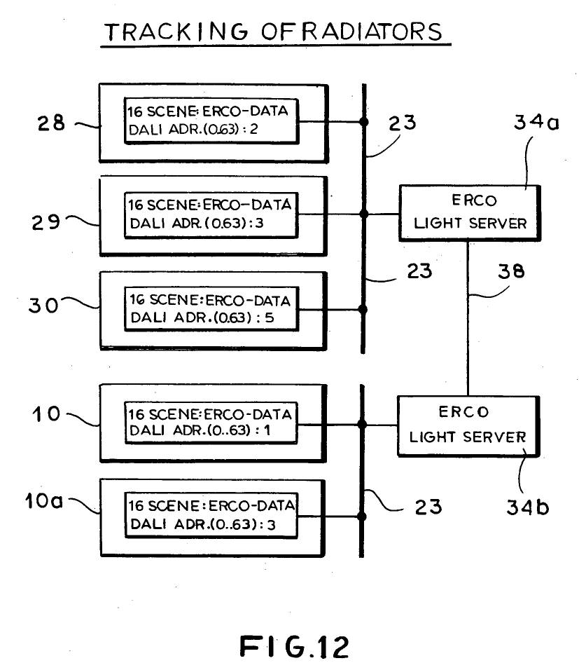

FIG. 12 a schematic illustration of two control units for controlling two different networks of lamps or luminaires and which are connected together.

The lamps or luminaires in the Figures as a whole with reference numerals 10, 10a, 28, 29 or 30 will be described essentially in connection with the schematic showing of FIG. 1. It should be noted that the same or comparable parts or elements in the Figures have been indicated with the same reference characters for the sake of simplicity and may be followed by small letters to indicate the different elements.

FIG. 1 shows a lamp 10 according to the invention which in the conventional manner has a lamp housing 11 formed with a light outlet opening 18 through which the light emerges as signified by a light beam 13 and is directed toward a surface 12 to be illuminated for example off a floor surface in the case of a ceiling-mounted lamp 10 which illuminates the floor 12.

In the housing 11 a reflector 17 is arranged which can be, for example, a parabolic shape. The lamp or luminaire 10 according to FIG. 1 has three light sources 14, 15, 16 which for example can be of different colors, for instance, red, green and blue. Each light source 14, 15, 16 is connected by its own line 24a, 24b, 24c with a respective electronic switching device 19, 20, 21. Each switching device is connected to a common signal transmission line 23 which can also be referred to as a bus conductor, and with a common voltage supply line 22. For the sake of simplicity electric lines in FIG. 1 are shown by single lines. The artisan will understand that the electric lines can be two wire or multi-wire lines. This can apply as well and preferably also for the bus conductor 23.

The three electronic switching devices 19, 20, 21 can is also be termed operating devices and can be formed in the embodiment illustrated as DALI switching units or so-called electronic control gear (ECG) or DALI control units which correspond to the DALI standard in accordance with DALI AG of ZVEI.

The switching devices 19, 20, 21 are individually addressable and can be individually controlled by a control unit 34 as has been illustrated by way of example in FIG. 2 and which may also be referred to as a DALI server or according to FIGS. 3-12 as a light server. Depending upon the control signal which is received by the switching device 19, the respective light source 14, for example, a red lamp can be switched on or off or dimmed. At the same time the other switching devices 20, 21 can receive independent control signals from the control unit 34 and correspondingly can control the respective green light source 15 or blue light source 16, for example, to dim or switch it on or off. For mixing the colors of the light source 14, 15, 16, the light 13 emitted by the lamp or luminaire 10 have their colors mixed or, should need arise, the respective light color change. Each switching device 19, 20, 21 is provided with its own memory 25, 26, 27 which has a singular code for the lamp 10. This code is inscribed in the memory 25, 26, 27 upon manufacture of the lamp 10. The function of the code is described hereinafter and as to it, it may be noted initially that it does not depend upon the structural configuration of the lamp or luminaire 10. Thus the light sources 14, 15, 16, the reflector and the switching devices 19, 20, 21 with respect to their number and also with respect to their arrangement can be configured optionally relative to the housing 11. It is also conceivable for example that the lamp or luminaire 10 will have only one light source and only one switching device with a memory.

FIG. 2 shows a network of three lamps or luminaires 28, 29, 30 each of which has its own memory 31, 32, 33. In the simplest case, each of the three lamps or luminaires 28, 29, 30 will have only one light source and only one memory 31, 32, 33. However, it is also possible equally that one or more of the three lamps or luminaires 28, 29, 30 can have a plurality of switching devices and a corresponding number of memories or light sources and thus a plurality of such memories or light sources.

The block diagram of FIG. 2 shows that the lamps or luminaires 28, 29, 30 form a network in which they are interconnected through a signal transmission or its line 23 with a control unit 34. It can be noted that FIG. 2 for clarity has not shown a voltage supply line 22 and in the lamps 28, 29, 30, the switching devices which are present have not been illustrated although the memories 31, 32 and 33 have been identified. The number of lamps or luminaires is optional and utilizing the DALI protocol can amount to 64 participants or subscribers. In the case of the use of a plurality of switching devices per lamp or luminaire, the use of up to 64 switching devices is permissible. The lamps or luminaires thus form a network or system of lamps 28, 29, 30 which can extend in or over different rooms A and B if desired which is indicated by the schematically illustrated wall W.

Each of the three lamps or luminaires 28, 29, 30 is provided with a different, singular code during its manufacture, i.e. at the factory, which code is inscribed or registered in the respective memory 31, 32, 33. This code is a kind of serial number and can be produced continuously, i.e. one number after the other in succession and is unreplaceable or interchangeable. It is inscribed or registered in a light scene memory of the switching device 31, 32, 33 which can be configured as a DALI ECG or switching device and is present there even before the installation of the three lamps 28, 29, 30 at their installation location according to FIG. 2. When the three lamps 28, 29, 30 are first connected to the common signal transmission line 23, through communication with the control device 24 without additionally requiring any action, an initialization of the operating system takes place which can be termed plug & play. The control unit 34 can distinguish the three lamps or luminaires 28, 29 and 30 because of their different codes in a simple manner. An operation such as has been used with the state of the art for a manual response of the lamp by causing them to blink, can be eliminated.

Especially advantageously the application of a singular code for each lamp or luminaire can be noticeable when a lamp or luminaire has a plurality of switching devices. This will be explained in greater detail in connection with FIGS. 3 to 12 which also describe the method steps of the fabrication process.

FIG. 3 shows an automatic test unit (test automaton) 35 which is brought into electrical connection with the lamp or luminaire after the mounting of the lamp 10. It functions as a kind of simulator for the control unit 34′ since the lamp 10 at the point in time in which FIGS. 3 to 6 are applicable is not at its installation location but still in the factory. The reference to a simulated control unit 34′ is thus only symbolic and in practice the test unit 35 will be so connected to the device 34′ that the operations of the memories 25, 26, 27 of the three switching devices 19, 20, 21 in the lamp 10 can be functional and the functionality of the control device 34 according to FIG. 2 at the installation site will be partly or completely assumed by the factory device.

FIG. 3 shows a table field T which displays the contents of the light scene memories or storage of the memories 25, 26, 27 of the thee DALI switching units 19, 20, 21 of the lamp or luminaire 10. It will be apparent that the memory can be subdivided into six different columns which can each hold different contents and which can be given the labels “DALI-Address” “Article Number”, “Color Code”, “EVG ID” (identified) “Lamp ID” and “Test sum”. The different columns can thus represent different light scene memories 25, 26, 27 in the electronic switching devices 19, 20, 21.

Each row of the table field T displays the entire memory content 25, 26, 27 of the light scene memory of a switching device 19,20, 21. Thus the first row of the table field T represents the entire memory content of the light scene memory 25 of the electronic switching device 19.

The mounted lamp 10 is fitted for example with three light sources and connected to the test unit 35 or the simulated control unit 34′. The test unit 35 assigns DALI addresses to the memories 25, 26, 27 or the three switching devices 19, 20, 21 of the lamp or luminaire 10 which serve to identify the switching devices unit, the test unit 35 for the simulated control unit 34′. FIG. 3 shows that the switching device 19 which has the memory is assigned the DALI address zero. The switching device 20 which has the memory 26 is assigned the DALI address 1.

If the lamp or luminaire is now connected to the control unit 34 and the latter reads out the memories, it will contain the data in accordance with the read out information field 36. It will be apparent that at this point in time, in accordance with FIG. 3, 16 light scenes are undefined, that is the light scene memories 1-16 are unwritten to and of the 64 possible DALI addresses, the addresses 0, 1 and 2 have been used.

FIG. 4 shows that in a second step using the test unit 35, the article number of the lamp or luminaire is inscribed in the memory 25, 26, 27 of the three switching devices 19, 20, 21. The selected article number 85.012.00 corresponds to the article number of this lamp. Advantageously, the article number is automatically inscribed by the test unit 35 and, for example, is assumed as a result of the testing of the lamp for appropriate installation and functioning.

FIG. 5 shows that up to this point in time an identification of the colors of the light sources responsive to the individual DALI switching devices has occurred. Thus the switching device 19 with the memory 25 has received the color code B (blue) for its light source, the switching device 27 with the memory 26 has received the color code G (green) for its light source and switching device 21 with the memory 27 has received the color code R (red) for its light source. These color codes are inscribed in the light scene memory.

In addition, the three ECGs (electronic control gears) or switching devices have their respective codes which, in the terminology of the table field T, is represented as to so-called ECG-ID. The switching device 19 with the memory slot 25 contains in accordance with FIG. 5 the ECG-ID number 3.

In a further step according to FIG. 6, the lamp or luminaire 10 itself is given a singular code (lamp ID) that is a luminaire identification number. The lamp 10 receives the code ID 1. The lamp ID can be calculated by the automatic test unit 35 from a testing unit number and the time, for example, calculated in milliseconds and the time can include for example also the date so that a singular code (lamp ID) which on a world-wide basis can be applied only once is possible. The lamp code is also electronically written into the three memory slots 25, 26, 27 of the three switching devices 19, 20, 21 by the test unit 35.

Finally, the test sum is formed and is likewise written as the codes, into the light scene memory 25, 26, 27 of the three switching devices 19, 20, 21. The test sums are formed from the contacts previously written into memory. The test sum X is assigned to the switching device 19 with the memory slot 25 and thus is formed from the article number written into memory is the color code, the ECG-ID and the lamp ID for the switching device 19. Similarly, the test sum Y is formed from the contents of the memory 26 of the switching device 20 and thus will differ from the test sum X in spite of the fact that both have the same lamp ID.

It will be apparent that a singular code is thereby created. The lamp ID code ID 1 is generated only once and is written into three memories 25, 26, 27 of the three switching devices 19, 20, 21.

Using a DALI switching device which has been the starting point for the description of the embodiment here, there are four bytes provided for the light scene storage location 1 to 16 which contain the complete factory applied data. There are for example seven bytes afforded for the lamp code (lamp ID), two bytes provided for the test sum, one byte for the ECG-ID, two bytes for the color code and four bytes for the article number.

The memory for the DALI address provided in the DALI switching device serves during the above-described testing and the inscription of the code indeed for the addressing of the different switching devices but not for the coding. The DALI switching device has in addition a memory for long addresses which can be addressable through the command “randomize” and with which the random addresses can be ordered. These random addresses however are not singular codes since the situation can arise that a random address can be used a multiple of times.

FIG. 7 shows the situation in which the lamp has been mounted at an installation location, that is for example at a location in the building at which a control unit 34 is connected with the lamp. For the sake of simplicity only three lamps 28, 29, 30 have been shown to be connected to the control unit 34. The table field T shows that the control unit 24 is initially set up for seven different switching devices and the three different lamps with random DALI addresses. The original DALI addresses which have been inscribed in the memory of the switching devices and at the factory represented the coding of the lamps were thus overwritten. In the table field T according to FIG. 7, the memory contents of the usual light scenes memory of the seven switching devices have not been shown since the codes for the three lamps 28, 29, 30 are stored therein and these lamps at this stage are merely provided with the DALI addresses automatically.

FIG. 8 shows that the control unit 34 can read out the contents of the table field T and thus the contents of the light scene memory of the seven switching devices for the three lamps 28, 29, 30. It will be apparent that under the DALI address 2, the switching device did not have an appropriate test sum and thus was shown to be a foreign lamp or a lamp whose lamp scene memory has already been overwritten. The remaining switching devices have been recognized from the respective codes (lamp IDs as ID1 or ID2) based upon the regularity of their test sum. The control device 34 recognizes the lamp 30 with the switching device with the DALI address 2 as a lamp which has no code since it does sum leads to a defect signal (error).

The control unit 34 composed upon the lamp codes (lamp Ids) can then effect a sorting as has been shown in FIG. 9. Here the switching devices 19, 20, 21 with the memories 25a, 26a, 27a belonging to the lamp 28 are assigned the lamp ID 1 as one so-called client or as one lamp 28 as recognized by the control unit.

To the lamp 29 are assigned the switching devices with the DALI addresses 4, 3 and 0 and the reference unit 25b, 26b and 27b. The lamp 30 is recognized as a foreign lamp with only one switching device.

To test the installation, the light scenes of the ECGs which are connected are called up for test purposes. The foreign lamp can be tested manually. A targeted addressing of the individual switching devices of a respective lamp is possible through the DALI addresses in which case the controller 34 determines which DALI addresses and thus which switching devices belong to which lamp.

Below, referring to FIG. 11, we will describe how the foreign lamp 30 can be provided with a code. For this purpose a transportable computer 37 is provided which can be connected with the control unit 34 at the installation site. The computer 37 is equipped like the test unit 35 to output singular codes. Since the computer 37 can be handled only by authorized personnel and is set up at the factory itself, it can output a singular code, i.e. a lamp ID for the lamp 30. The assignment of a lamp ID to the lamp 30 is not absolutely necessary although it is advantageous.

The lamps 28 and 29 connected to the control unit 34 and recognized by it, have an article number which is recorded in column 2 of table field T. The control unit 34 can determine from the article number of a particular lamp, the technical characteristics of this lamp and which relate to this lamp or this lamp type. For example it is possible that the control unit 34 will read out from a data base information can which include for example a photograph or image of the associated lamp with this article number so that the lamp photograph can be displayed at the control unit 34 to thereby simplify further servicing. The technical information associated with the lamp like for example the order number for parts or accessories for purposes of replacement or repair can also be stored in a data base of the control unit 34.

The control unit 34 can directly determine the technical characteristics and further information as to the lamp, as far as it is desired, at any appropriate time also directly from the light scene memory of the switching device. Thus the control device 34 can determine from the switching device with the memory 27a of the lamp 28 that this switching device controls a light source of the color red.

It is also possible that the control unit 34 can deduce technical information as to the lamp directly from the code, for example the light ID of the lamp. For this purpose the control unit 34 can address a data base which contains a table in which the desired technical data or other information can be stored based upon the code.

FIG. 12 explains that a first control unit 34a with which for example the lamps 28, 29 and 30 are associated and a second control unit 34b with which the lamps 10 and 10a are associated can be connected with one another through the connecting line 38. If for example in a museum, it should prove to be important to find out where a certain lamp is located, this can be achieved immediately through the coding. Should the central office of a museum seek to determine where all of the lamps of a certain type (that is for example with the same article number) are to be found, this can be achieved by interrogating the system as to the article number based upon the coding.

Alternatively, operating times of the light sources and other appropriate information can be obtained by accessing the data base for the individual lamps or lamp type to make such information readily available. This simplifies the operation of a lighting system even with a large number of lamps. The control unit can access a data base which contains the information with respect to the lamps or the lamp type. The control unit can associate this information with such data and information from the data base and which can be read from the memories of the lamps.

From the aforedescribed embodiments it will be apparent that for the case in which there is no code in the memory, especially in the memory of an operating device for a lamp or a special memory of the lamp but rather only an information data set or some other data set has been inscribed in the memory, the same steps which were applied on manufacture of the lamp or the manufacture of the operating device can be undertaken so that the inscription of the information data set or the other data set will have comparable advantages to those obtained with coding. The information which has been described based upon examples explicitly directed to electronic switching devices or electronic control gear can be equally applied to any optional operating units for light sources of lamps for example, the transformers, dimmers, LED-RGB control units, DALI protective devices, for example, relays or the like.

1. A lamp or luminaire (10, 10a, 28, 29) for illuminating a building surface, a part of a building surface or an external surface (12), characterized in that the lamp or luminaire has a memory (25, 26, 27, 31, 32, 33, T, 25a, 26a, 27a, 25b, 26b, 27b) in which a code is recorded which is singular, factory produced and enables an identification of the lamp or luminaire (lamp ID) and which is electronically readable.

2. The lamp or luminaire according to claim 1, characterized in that the lamp or luminaire has a housing (11) for at least one light source (14, 15, 16).

3. The lamp or luminaire according to claim 2, characterized in that the memory is fixed relative to the housing (11) and is especially arranged within the housing.

4. The lamp or luminaire according to claim 1, characterized in that the lamp or luminaire has at least one switching device (19, 20, 21) for controlling at least one light source (14, 15, 16) and connectable with a control unit (34a, 34b, 34c).

5. The lamp or luminaire according to claim 4, characterized in that the memory is adapted to be read out by the control unit.

6. The lamp or luminaire according to claim 4, characterized in that the switching device is a DALI switching device or electronic control gear.

7. The lamp or luminaire according to claim 6, characterized in that the code is received in a light scene memory (T) of the DALI switching device.

8. The lamp or luminaire according to claim 7, characterized in that the code occupies the storage locations 7 to 16 of the light scene memory.

9. The lamp or luminaire according to claim 4, characterized in that by means of the code, the switching device (19, 20, 21) is singularly or specifically identifiable as to its association with the lamp or luminaire (10).

10. The lamp or luminaire according to claim 4, characterized in that the memory is assigned to the switching device and especially is arranged in the switching device.

11. The lamp or luminaire according to claim 4, characterized in that the lamp or luminaire has a plurality of light sources (14, 15, 16) and a plurality of switching devices (19, 20, 21).

12. The lamp or luminaire according to claim 11, characterized in that a plurality of switching devices (19, 20, 21) of a lamp or luminaire (10; 28) each has a memory (25, 26, 27; 25a, 26a, 27a) associated therewith and having the same code.

13. The lamp or luminaire according to claim 11, characterized in that a plurality of switching devices of a lamp (10) each have different factory provided subcodes (ECG-ID) enabling identification of the individual switching device.

14. The lamp or luminaire according to claim 11, characterized in that each light source (14, 15, 16) has a respective switching device assigned thereto.

15. The lamp or luminaire according to claim 1, characterized in that the code (lamp ID) has a test sum.

16. The lamp or luminaire according to claim 15, characterized in that the test sum is testable by the control unit.

17. The lamp or luminaire according to the preamble of claim 1, especially in accordance with one of the preceding claims, characterized in that the lamp or luminaire has a memory in which an information data set (T) is inscribed at the factory which contains lamp-type specific data like for example the article number of the lamp and/or the number of the switching device assigned to the lamp and/or the number of the light source or light sources and/or the colors (color codes) of the light sources, or the like.

18. The lamp or luminaire according to the preamble of claim 1, especially in according with one of the preceding claims, characterized in that the lamp has a plurality of switching devices and that each switching device has a memory in which a data set is inscribed at the factory which contains light-type specific data and/or switching device relevant data, like for example the article number of the light, the colors of the light sources connected with the switching devices, the types of the light sources connected with the switching devices or the like.

19. The lamp or luminaire according to claim 4, characterized in that a control unit (34, 34a, 34b) is provided by means of which the code or by means of which the information data set or by means of which the data set of the lamp or luminaire or of the switching device is referred to data relating to this lamp or this switching device.

20. A method of making a lamp or luminaire (10, 10a, 28, 27, 29), especially for producing a lamp or luminaire in accordance with the preceding claims, characterized in that a method step is provided in which each lamp is provided with a singular code (lamp ID).

21. A device for use in a method of producing a lamp or luminaire, especially for use in the method according to claim 20, characterized in that a device (35, 34′) is provided in which each of the lamps (10, 10a, 28, 29) produced by the device is given a singular code (lamp ID).

22. An operating device, especially an electronic switching device or an electronic control gear, for a lamp or luminaire, especially for a lamp or luminaire in accordance with claim 1, characterized in that the operating device (19, 20, 21) has a memory (25, 26, 27, 31, 32, 33, T, 25a, 26a, 27a, 25b, 26b, 27b) in which a code (lamp ID) is provided which is singular, factory applied and enables identification of the operating device and which is electronically readable.

23. The operating device, especially the electronic switching device or electronic control gear especially in accordance with claim 22 for a lamp or luminaire, characterized in that operating device (19,20, 21) has a memory (25, 26, 27, 31, 32, 33, T, 25a, 26a, 27a, 25b, 26b, 27b) in which a data set is registered at the factory which contains data specific to the operating device like for example an article number of the operating device, information as to the supplier of the operating device, that means for example as to a specific source of the light sources included therein or light source types or the like.
